(19) United States
(12) Patent Application Publication
(10) Pub. No.: US 2004/0049443 A1
(43) Pub. Date: Mar. 11, 2004

(54) Quantitative method and system for short-term trading of stocks

(76) Inventor: Jeffrey S. Marcus, Ridgefield, CT (US)

Correspondence Address: JEFFREY S. MARCUS, 232 PEACEABLE STREET, RIDGEFIELD, CT, 06877, US

(21) Appl. No.: 10/185,680

(22) Filed: Jul. 1, 2002

(51) Int. Cl. G06F 17/60

(52) U.S. Cl. 705/37; 705/1

(57) ABSTRACT

In accordance with the Invention there is provided a stock trading system that defines the exact circumstances, date, and time under which shares of stock are to be purchased, a specific holding period for each stock purchased and the exact day and time when the shares of stock are to be sold. The Invention is defined by its (1) Filter Rules—which identify the stocks to be purchased, (2) Trading Rules—which describe in detail exactly how and when said stocks will be purchased and sold, and (3) an Optimal Holding Period which relates to (2). The Invention accomplishes investors' goals, which have remained unsatisfied for centuries, of profiting from the temporary emotional excesses and variability of the stock market. The Invention improves upon the existing arts of Fundamental, Technical, and Quantitative stock selection and trading, by providing an exact method for buying and selling stock. The Author defines the Invention as a system and method that applies to both long and short trading strategies.

### REFERENCES

Patents—the author of the Invention conducted a patent search for related or similar patents on the USPTO website. No related or similar patents were found.

Other References:

Malkiel, Burton G./Campbell, John Y./Lettau, Martin/Xu, Yexiao, “Have Individual Stocks Become More Volatile? An Empirical Exploration of Idiosyncratic Risk” NBER Working Paper No. w7590 March 2000

Chan, Wesley S., “Stock Price Reaction to News and No-News: Drift and Reversal After Headlines” MIT May 11, 2001.

French, Kenneth R. and Richard W. Roll, “Stock Return Variance: The Arrival of Information and the Reaction of Traders”, Journal of Financial Economics 19, 3-30 1986

Barber, Brad M. and Terrance Odean, “All That Glitters: The Effect of Attention and News on the Buying Behavior of Individuals and Institutional Investors” NBER September 2001

### BACKGROUND OF INVENTION

The US stock market has existed for over a century and speculation has existed since the latter part of the middle ages. Currently, approximately 70% of the US population is directly or indirectly invested in the stock market. 2.8 million people professionally advise investors (Appendix One). At this writing, the market value of all stocks in the N.Y. Stock Exchange Composite and the NASDAQ Composite is $16.96 Trillion. All these people and all this money are utilizing thousands of strategies for making money by trading stocks. Yet, over centuries of speculation two factors have remained constant in the stock market—FEAR and GREED.

It is FEAR, which takes the form of panic and GREED in the human emotion euphoria, which provide opportunities for investors to profit. FEAR temporarily drives stock prices to extremely low levels as investors sell to preserve capital. GREED pushes prices to unjustifiably high levels in the short term as investors desire for wealth overcomes logic and rationale.

The solution, long sought by investors, has been a way to make money in stocks by eliminating the natural impulses of FEAR and GREED, while taking advantage of the majority of investors who succumb to emotion. The Holy Grail of investing is a systemic method of buying and selling securities, which will minimize risk and maximize return. The Invention accomplishes investors' long-sought goal by setting up strict rules for purchasing and selling securities that allow them to take advantage of the market's propensity for emotion (Appendix 5 and 6).

Several recent developments allow for the ability of the invention to produce outsized results:

1. The speed of microprocessors and the availability of updateable data have made the manipulation and sorting of data possible on a minute-by-minute basis. This makes rapid buy and sell decisions possible.

2. The markets and therefore stocks have become increasingly volatile. Volatility leads to greater opportunity to take advantage of large price swings (Appendix Two)

3. More of the population (approximately 70% in the US) now owns stocks; either through mutual funds or directly and the holding periods for investors have shrunk from 5 to less than 3 years. More inexperienced investors with less patience have lead to increased volumes and volatility (Appendix Three).

4. The availability and widespread use of electronic trading makes it easier for all investors to make quick and numerous buy and sell decisions. Again, this creates more opportunities to profit from larger and more frequent price swings.

5. Recent sharp reductions in commission rates charged by brokers—especially electronic brokers can translate into higher profits for transaction-oriented investment strategies.

These recent developments do not represent an anomaly, but a trend which will become more pronounced in time; making the Invention even more profitable and, therefore, more useful in the future. In summary, the following seven factors allow for the Invention's efficacy, usefulness, and profitability:

1. Increased volatility of the markets

2. Increased volatility of individual stock prices

3. Speed, amount, and detail of news assimilation (economic, company, geopolitical)

4. Speed of trading (technology)

5. Focus on the short-term

6. High percentage of the public involved in the equity market

7. Increased number of professional market participants—explosion in the number hedge funds and mutual funds

Researchers have reported on the increase in volatility, the tendency for extreme price movements to retrace their paths, and the effects of trading on volatility. One of the findings of Wesley S. Chan's (MIT 2001) study “Stock Price Reaction to News and No News: Drift and Reversal After Headlines” was “. . . evidence of reversal after extreme price movements that are unaccompanied by public news.”. In 1986, French and Roll found that the act of trading increases volatility. In a 2001 NBER working paper, Malkiel, Campbell, Lettau, and Xu found that “. . . over the period 1962-1997 there has been a noticeable increase in firm-level volatility . . . the number of stocks needed to achieve a given level of diversification has increased.”

The Author of the Invention has worked on equity trading desks for over 15 years (see Author's Background). In December of 2001 the Author began to test several strategies that he had developed from his long career in the field of investments. In March of 2002, the Author began to empirically test the Invention. The Filter Rules, Trading Rules and OHP (Optimal Holding Period) and method of calculation were developed and defined between March and June of 2002.

### BRIEF SUMMARY OF INVENTION

The Invention is a quantitative stock trading system that defines the exact circumstances, date, and time under which shares of stock are to be purchased, a specific holding period for each stock purchased and the exact day and time when the shares of stock are to be sold.

In the Investment Field there are several methods of analyzing stocks and determining which stocks to buy and/or sell. They can be broken down into main categories:

1. Fundamental Analysis—is a method of forecasting a company's future and, therefore, the direction of its stock price, which is based on sales, earnings, and the value of the company's assets.

2. Technical Analysis—is a method of forecasting a company's future by looking at price and volume.

3. Quantitative Methods—use systems that repeatedly use the same calculations to forecast a stock's future or find attractive stocks.

The Invention improves upon each of these disciplines.

1. Unlike Fundamental Analysis, the Invention eliminates subjectivity, which is affected by human emotion.

2. The Invention draws from the tenets of Technical Analysis, but uses exacting filters that allow no room for interpretation. By removing the ability of the investor to bring his own judgment into the stock selection and trading experience, the Invention eliminates potential flaws in the investing process.

3. The Invention is quantitative by nature, but in addition to a quantitative selection process, a quantitative trading process is utilized to eliminate human interpretation, subjectivity and error form the trading part of the strategy.

4. Unlike every other method and strategy of trading, The Invention eliminates the chance for human error by detailing ever step of the selection process and trading method, through use of the Filter Rules and Trading Rules, respectively.

The Author of the Invention will explain that, although the language of this Patent Application refers to first purchasing and then selling stock (commonly referred to as going long stock), that the Invention also applies to first selling stock and then buying it back (commonly refereed to as going short stock). Short selling can be profitably accomplished by the Invention.

### DETAILED DESCRIPTION OF THE INVENTION

This section will proceed as follows:

1. A definition of terms

2. Identification of the main elements of the Invention

3. An explanation of the main elements of the invention

4. Population of potential “Users of the Invention”

5. Statement that the Invention can be used as a Short and Long Strategy

1. Definition of Terms

The following terms and their corresponding definitions will used to describe the Invention:

1. STOCK—shares of ownership in publicly traded companies

2. STOCK PRICE—last price of the stock during regular hours of trading

3. LAST PRICE—the last price at which a share of stock trades

4. CLOSING PRICE—the last price for a share of stock on a given day and the price that will appear in the following day's Wall Street Journal

5. 1 DAY PRICE CHANGE—change from previous day's closing price to last price

6. REGULAR HOURS OF TRADING are 9:30 AM-4:00 PM in the US

7. PURCHASE DAY—day the stock will be purchased

8. SCREENING TIME—a time close to, but before 4:00 PM on the purchase day that allows enough time to execute orders

9. UNIVERSE OF STOCKS—the entire list of stocks that is followed by Value Line or a sinular universe which includes most publicly held common stocks (approximately 6000 stock in June 2002)

10. HOLDING PERIOD—the number of days an investment is held

11. OHP—the Optimal Holding Period (as defined in this patent application)

12. 20-DAY AVERAGE VOLUME—the average shares of stock traded daily in any given stock measured over the last 20 trading days.

13. TOTAL ASSETS—all assets in a portfolio that is using the invention's strategy

2. Identification of Main Elements

The Invention relates to a stock trading system that defines the exact circumstances, date, and time under which shares of stock are to be purchased, a specific holding period for each stock purchased and the exact day and time when the shares of stock are to be sold.

The Invention's description is divided into two main parts or rules; (1) Filter Rules and (2) Trading Rules. It is the combination of the Filter Rules and Trading Rules, which define the Invention.

Each trading day the Invention begins at Screening Time with the entire Universe of Stocks and through a series of filters, stocks are eliminated until only the stocks that satisfy each filter and its specified conditions remain. The stocks that remain after all filters are satisfied are the stocks, which will be purchased that day. Once the group of stocks that will be purchased for that day are established by the Filter Rules, the Trading Rules are utilized. The Trading Rules will determine all actions to be taken after the Filter Rules have established the stocks to be purchased for the day.

Filter Rules apply in the following order:

1. Begin with all stocks in the entire Universe of Stocks

2. Last Price is at least $10

3. 20 Day Average Volume is at least 50,000 shares

4. 1-Day Price Change has been negative for 2 consecutive days (Closing Price to Screening Time constitutes 1 Trading Day).

5. The CUMULATIVE TWO DAY PRICE CHANGE must be a magnitude of at least −10% (for example: a Two Day Price Change of +15%, +2%, −5% or −9.99999999% does NOT satisfy the Filter Rules, whereas −10%, −10.1111111%, −11% or −45% all satisfy the Filter Rules)

6. A stock cannot be purchased if it was purchased within a 30 days of the Purchase Day

Trading Rules:

1. If Filter Rules 1-6 are satisfied, buy the stock as close to 4:00 as possible

2. Dollars to be invested each day=Total Assets divided by the OHP

3. Dollars to be invested in each position or individual stock=Dollars to be invested each day divided by the number of stocks that satisfy the Filter Rules for that day

4. No position may constitute more than 20% of the Total Assets so if there is only one stock that satisfies the Filter Rules, ONLY 20% of the Total Assets are invested in this stock.

5. Stocks positions are held for the OHP and sold as close to 4:00 EST as possible after being held for the OHP.

3. Explanation of Main Elements

In this section, the Author explains the reasoning behind the Filter Rules and Trading Rules. Each filter and rule has a purpose and is designed to create greater profits for the user of the Invention.

FILTER RULES

1. The entire universe of stocks is used to allow the greatest chance to find a profitable opportunity. The entire universe of stocks was also used during development and testing of the Invention.

2. Only stocks with prices $10 and higher are purchased, because of the observed tendency for stocks under $10 to head lower. This tendency may be due to many factors which may include:

a. The tendency for institutions to avoid low priced stocks to avoid filing requirements

b. Small net moves in lower priced stock translate into high percentage moves that may not necessarily mean that investors panicked and may, instead, indicate a medium or long term downward trend in the stock

3. The 20 Day Average Volume filter prevents the Invention from choosing stocks which are illiquid and, therefore, difficult to trade.

4. The filter that deals with the stock's price being down two consecutive days is THE MOST CRITICAL PART OF THE INVENTION. Many traders and short-term investors focus on stocks with large daily price moves. Although it may seem simplistic, two days of negative price movement versus one day of negative price movement implies that:

a. The downward movement has had time to attract the attention of potential buyers

b. People who wanted to sell shares in the stock have had ample time to sell Each one of these ideas is important, because the Invention does not claim to work (be profitable) in the medium or long term. The Invention is capturing the affect of a stock being down TOO FAR and TOO FAST. The Invention takes advantage of the tendency for stocks to NOT MOVE INA STRAIGHT LINE. Stock prices snap back after big moves and the Invention works because of this tendency.

5. The stock price dropping at least 10% in 2 days makes the stock attractive to bargain hunters. The idea is to choose stocks that become cheap enough that buyers will feel more comfortable. The lower price brings in more buyers and the stock price will, subsequently, be driven up faster.

6. The Invention attempts to avoids buying stocks that are in medium-term down trends by not buying the same stock repeatedly. If a stock satisfies the filters twice within a 30-day time frame, it will not be purchased by the Invention.

Trading Rules

1. Once the stocks that have satisfied the Filter Rules have been identified, they are purchased as close to 4:00 EST as possible. The Invention is based on closing prices, so the stocks should be purchased as close to the closing price as possible.

2. The Invention attempts to be fully invested at all times. In order to be filly invested, the Dollars to be Invested Each Day are calculated by dividing the Total Assets by the OHP. If the Invention tells the investor to buy stocks on consecutive trading days for ever day of the OHP, the investor will be fully invested.

Example: If the OHP=3 days and the Total Assets are $1,000,000, then the Dollars to be Invested Each day =$333,333.33.

3. Dollars to be invested in each position=Dollars to be invested each day divided by the number of stocks to be purchased.

Example: If the Dollars to be Invested Each Day=$333,333.33 and the number of stocks to be purchased=3, then the Dollars to be invested in each position=$111,111.11.

4. In order to reduce the risk of one losing position causing excessive losses relative to the Total Assets, the Invention places a limit on the amount of dollars that can be invested in any single stock. A maximum of 20% of the total assets can be used to buy any one stock.

Example: If only one stock passes all the Filter Rules on a given day and the Total Assets are $1,000,000, than only $200,000 can be used to buy that stock.

5. All stocks purchased are held for the OHP (Optimal Holding Period). The OHP is monitored daily by using an Excel Spreadsheet that holds all data since Mar. 8, 2002. A formula to calculate OHP takes into account the return for each position by the days held. An average return for number of days held is calculated for the holding periods 1, 2, 3, 4, 5, 6, 7, 8, 9, and 10 days. The spreadsheet then searches for the maximum average return for each of 5 time frames and weights the holding periods in the following manner:

| TIME FRAME | WEIGHT |
|---|---|
| 1. ALL THE DATA POINTS (SINCE Mar. 8, 2002) | 50% |
| 2. LAST 25 DATA POINTS | 30% |
| 3. LAST 50 DATA POINTS | 10% |
| 4. LAST 75 DATA POINTS | 5% |
| 5. LAST 100 DATA POINTS | 5% |

(Appendix Four)

4. Population of Potential “Users of the Invention”

“Users of the Invention” Includes Anyone Who Has:

1. An updated list of stocks which constitutes the Universe of Stocks

2. Access to a database which will provide the necessary updated price, volume, and market information

3. The capital and ability to trade

4. The skill to calculate the OHP

There are multitudes of trading strategies that have been developed, marketed, utilized, and discarded which attempted to profitably buy and sell stocks. The Invention distinguishes itself because its users are provided with a well-defined roadmap to profitability:

1. Filter Rules—which provide a specific and detailed method to pick a group of stocks to be purchased every day. The rules are exact and leave no room for ambiguity. By removing subjectivity, the Invention removes the emotional factor, which the Author believes is the downfall of most trading strategies.

2. Trading Rules—once the group of stocks to be purchased has been found, the Invention provides and exact method to buy those securities and the exact number of shares to be purchased. The Invention then tells the investor exactly what day and time to sell each stock.

3. OHP—the invention monitors, on a daily basis, the Optimal Holding Period and adjusts to market changes by changing the OHP to produce the best results.

5. Statement that the Invention can be Used as a Short Strategy or Long Strategy

Most investors are familiar with going “long” shares of stock. An investor (the term “investor” will include traders for the purpose of this explanation) is long stock, if the investor first buys the stock (creating the long position) and later sells the stock (eliminating the long position). The investor buys first, because he believes the price of the stock will increase, which will allow him to sell it later at a higher price. A less common practice is “shorting” or a “short sale” of stock. When an investor shorts a stock he believes the price of the stock will decline. The investor sells the stock, hoping to buy it back (commonly referred to as “short covering”) later at a lower price.

The Invention can be used to sell short stock and to buy back or short cover, in addition to going long stock and subsequently selling that long position. The only difference is the direction of price moves used in the Filters. In order to use the Invention to short stocks, the following changes are made to the Filters:

Filter Rules apply in the following order:

7. Begin with all stocks in the entire Universe of Stocks

8. Last Price is at least $10

9. 20 Day Average Volume is at least 50,000 shares

10. 1-Day Price Change has been positive for 2 consecutive days (Closing Price to Screening Time constitutes 1 Trading Day).

11. The CUMULATIVE TWO DAY PRICE CHANGE must be a magnitude of at least +10% (for example: a Two Day Price Change of −15%, −2%, +5% or +9.99999999% does NOT satisfy the Filter Rules, whereas +10%, +10.1111111%, +11% or +45% all satisfy the Filter Rules)

12. A stock cannot be sold if it was purchased within a 30 days of the Purchase Day

Trading Rules:

6. If Filter Rules 1-6 are satisfied, sell short the stock as close to 4:00 as possible

7. Dollars to be invested each day=Total Assets divided by the OHP

8. Dollars to be invested in each position or individual stock=Dollars to be invested each day divided by the number of stocks that satisfy the Filter Rules for that day

9. No position may constitute more than 20% of the Total Assets so if there is only one stock that satisfies the Filter Rules, ONLY 20% of the Total Assets are invested in this stock.

10. Stocks positions are held for the OHP and bought back as close to 4:00 EST as possible after being held for the OHP.

What I claim as my invention is:

1. A stock trading system or method that utilizes the Filter Rules described above in the Specification.

2. A stock trading system or method that utilizes the Trading Rules described above in the Specification.

3. A stock trading system or method that utilizes a combination of both the Trading Rules and the Filter Rules described above in the Specification.

4. A stock trading system or method that utilizes an Optimal Holding Period, as described above in the Specification.

5. A stock trading system or method that combines claim 1 and claim 4.

6. A stock trading system or method that combines claim 2 and claim 4.

7. A stock trading system or method that combines claim 3 and claim 4.

8. A stock trading system or method that can be used as a long or short strategy (as defined in the Specification).
